(19) United States
(12) Patent Application Publication
(10) Pub. No.: US 2020/0387852 A1
(43) Pub. Date: Dec. 10, 2020

(54) VEHICLE MANAGEMENT APPARATUS AND VEHICLE MANAGEMENT METHOD

(71) Applicant: HONDA MOTOR CO., LTD., Tokyo (JP)

(72) Inventors: Fujio Iida, Wako-shi (JP); Toshiaki Sumi, Wako-shi (JP); Tsunehisa Hata, Wako-shi (JP); Takanori Hashimoto, Wako-shi (JP); Daisuke Tomomatsu, Wako-shi (JP); Nao Sugimoto, Wako-shi (JP); Kazumi Ogawa, Wako-shi (JP)

(21) Appl. No.: 16/884,685

(22) Filed: May 27, 2020

(30) Foreign Application Priority Data
Jun. 5, 2019 (JP) 2019-105011

(51) Int. Cl. G06Q 10/08

(52) U.S. Cl. CPC G06Q 10/083

(57) ABSTRACT

A vehicle management apparatus includes: a vehicle information acquirer acquiring a position of a vehicle designated as a delivery destination of a package; a condition acquirer acquiring an instruction from a recipient of the package, or a reception condition including an action schedule of the recipient; and a determination section determining, based on the reception condition, whether the vehicle that has the package delivered is to be moved from the position acquired by the vehicle information acquirer.

### INCORPORATION BY REFERENCE

The present application claims priority under 35 U.S.C. § 119 to Japanese Patent Application No. 2019-105011 filed on Jun. 5, 2019. The content of the application is incorporated herein by reference in its entirety.

### BACKGROUND OF THE INVENTION

### Field of the Invention

The present invention relates to a vehicle management apparatus and a vehicle management method.

### Description of the Related Art

It has conventionally teen proposed to use a vehicle as a delivery destination to which a package is delivered (see, for example, Japanese Patent Laid-Open No. 2018-204363). Japanese Patent Laid-Open No. 2018-204363 discloses a system that enables a deliveryman who delivers a package to a vehicle to unlock the vehicle using a terminal, in which the package is delivered to, other than a vehicle of a user who receives the package, for example, a vehicle that is placed at a used car dealer.

By the way, even when a package is delivered to a vehicle, a person who receives the package needs to go to the delivery location to receive the delivered package. Thus, it has been required to further reduce the burden on the person who receives the package. On the other hand, when delivery is made at the convenience of the person who receives the package, a problem occurs in which the delivery efficiency decreases.

An aspect of the present invention has been made in view of the above background and has an object to reduce a burden on a recipient to receive a package without preventing efficient delivery of the package.

### SUMMARY OF THE INVENTION

One aspect of the present invention is a vehicle management apparatus including: a vehicle information acquirer acquiring a position of a vehicle designated as a delivery destination of a package; a condition acquirer acquiring an instruction from a recipient of the package, or a reception condition including an action schedule of the recipient; and a determination section determining, based on the reception condition, whether the vehicle that has the package delivered is to be moved from the position acquired by the vehicle information acquirer.

According to other aspects of the present invention, there is provided a candidate determining section determining, for a reception location of the package, a candidate capable of accommodating the vehicle, wherein the determination section determines to move the vehicle when there is the candidate for the reception location satisfying the reception condition based on the reception condition.

According to other aspects of the present invention, the action schedule includes a move destination to which the recipient moves and a time at which the recipient arrives or stays at the move destination, and the determination section determines to move the vehicle when the recipient and the vehicle can move to the candidate for the reception location without change of the move destination and the time that are included in the action schedule.

According to other aspects of the present invention, there is provided: a vehicle move manager determining, from the candidate for the reception location, a move destination of the vehicle; a schedule changer adding, as a new via point, a position of the move destination of the vehicle to the action schedule; and a notification section notifying the recipient of addition of an event including the via point for the action schedule.

According to other aspects of the present invention, the notification section, to a navigation device equipped in a vehicle which the recipient gets in and is different from the vehicle designated as the delivery destination of the package, transmits information for setting the via point on a guidance route.

According to other aspects of the present invention, the vehicle move manager, when enabling to acquire information showing an acceptance of the notification by the recipient, generates a move plan for moving the vehicle from the position acquired by the vehicle information acquirer to the move destination.

Furthermore, one aspect of the present invention is a vehicle management method including: a step of acquiring a position of a vehicle designated as a delivery destination of a package; a step of acquiring an instruction from a recipient of the package, or a reception condition including an action schedule of the recipient; and a step of determining, based on the reception condition, whether to move the vehicle that has the package delivered.

An aspect of the present invention can reduce the burden on the recipient to receive the package that is delivered to the vehicle, for efficient package delivery.

### BRIEF DESCRIPTION OF THE DRAWINGS

FIG. 1 is a schematic view showing a configuration and function of a delivery management system according to an embodiment;

FIG. 2 is a sequence view showing an operation example of the delivery management system;

FIG. 3 is a sequence view showing another operation example of the delivery management system;

FIG. 4 is a functional block view showing a configuration of an in-vehicle system of a delivery destination vehicle;

FIG. 5 is a functional block view of a vehicle management apparatus;

FIG. 6 is a view showing a configuration example of action schedule information; and

FIG. 7 is a flowchart showing operations of the vehicle management apparatus.

### DETAILED DESCRIPTION OF THE PREFERRED EMBODIMENT

Hereinafter, an embodiment of the present invention will be explained with reference to the drawings.

### 1. Configuration of Delivery Management System

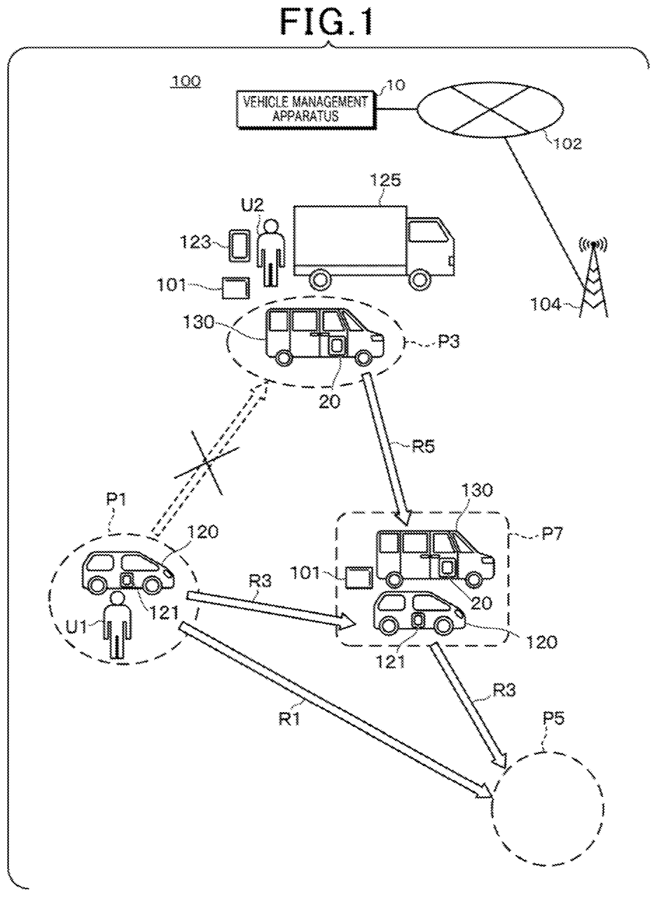

FIG. 1 is a schematic view showing a configuration and a function of a delivery management system 100 according to one embodiment of the present invention. The delivery management system 100 is a system that performs processing relating to delivery of a delivery item 101, and includes a vehicle management apparatus 10, an in-vehicle control unit 20, a user terminal 121, and deliveryman terminal 123.

The delivery item 101 is a package that is sent out from a sender, which is not shown, a recipient who receives the delivery item 101 is a user U1, and a carrier staff who delivers the delivery item 101 is a user U2.

A user vehicle 120 is a vehicle that is used by the user U1, and the user terminal 121 is a terminal device that is used by the user U1. The user terminal 121 may be, for example, a portable device such as a smartphone or a tablet computer that is used by the user U1. Furthermore, the user terminal 121 may be a device that is fixedly placed in the user vehicle 120, for example, car navigation device.

The user vehicle 120 is a moving object that is temporarily or continuously managed or used by the user, which may be a vehicle that is owned by the user, or may be provided to the user by car sharing, rental car, car lease, or the like.

A delivery vehicle 125 is a vehicle that is used by the user U2 for transporting the delivery item 101.

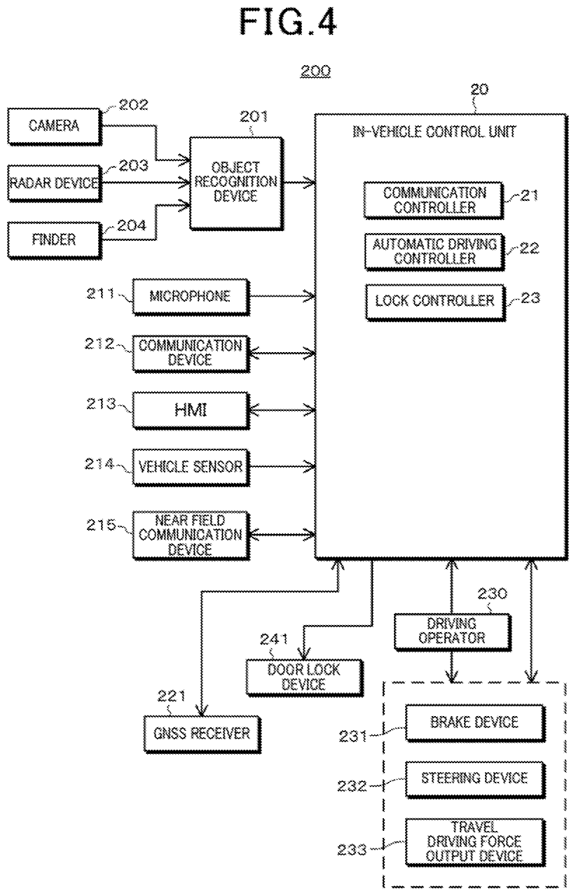

A delivery destination vehicle 130 is a vehicle that is used as a delivery destination of the delivery item 101 as described later. The delivery destination vehicle 130 is equipped with an in-vehicle system 200 including the in-vehicle control unit 20. A configuration of the in-vehicle system 200 will be described later with reference to FIG. 4.

The user vehicle 120, the delivery vehicle 125, and the delivery destination vehicle 130 may be any vehicles as long as capable of moving the delivery item 101, for which four-wheeled vehicles, motorcycles, or others such as light vehicles may be used. The type, size, and state of the delivery item 101 are also not particularly limited.

The delivery management system 100 uses communication by a communication network 102. The communication network 102 connects various devices so that they can communicate with each other. The communication network 102 is not limited to any specific aspect and, for example, is configured to include a communication network such as a dedicated line, a public line, or the Internet. Furthermore, the communication network 102 may be a wide area network including a plurality of communication networks. Furthermore, the communication network 102 may include various devices such as a line switching device and a server. The communication network 102 includes a wireless communication line that uses a base station 104. The base station 104 is, for example, a base station that is installed by a mobile network operator, and allows the user terminal 121, the deliveryman terminal 123, and the in-vehicle control unit 20 to perform wireless communication.

### 2. Outline of Processing Associated With Delivery

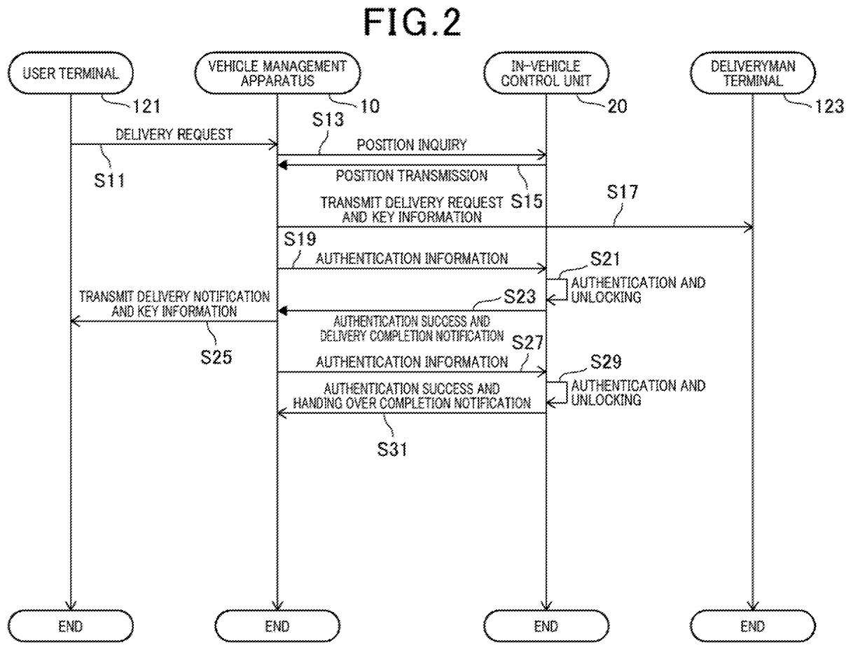

FIG. 2 is a sequence view showing an operation example of the delivery management system 100.

The delivery management system 100 corresponds to a delivery method of delivering the delivery item 101 to the delivery destination vehicle 130.

As shown in FIG. 1, when the delivery destination vehicle 130 that is parked at a delivery location P3 is designated as a delivery destination, the user U2 transports the delivery item 101 to the delivery location P3 by the delivery vehicle 125. The user U2 uses the deliveryman terminal 123 to unlock a door lock of the delivery destination vehicle 130 and places the delivery item 101 in a passenger compartment or a trunk of the delivery destination vehicle 130. The delivery task of the user U2 is thereby completed.

After the delivery item 101 is delivered to the delivery destination vehicle 130, the user U1 goes to the delivery location P3 that is a parking location of the delivery destination vehicle 130. Transportation means that is used by the user U1 is not limited, and a method of using the user vehicle 120 is one example.

The user U1 unlocks the door lock of the delivery destination vehicle 130 and receives the delivery item 101.

The mechanism of unlocking the door lock of the delivery destination vehicle 130 includes various aspects. In the present embodiment, to unlock the delivery destination vehicle 130, the user U1 uses the user terminal 121, and the user U2 uses the deliveryman terminal 123. The user terminal 121 and the deliveryman terminal 123 in this case are called key devices. The in-vehicle control unit 20, for example, executes the key device and near field communication and collates key information that is included in the key device with authentication information that is included in the in-vehicle control unit 20, thereby executing authentication. If the authentication is successful, the in-vehicle control unit 20 unlocks the door lock of the delivery destination vehicle 130. Examples of the near field communication that is executed by the in-vehicle control unit 20 include bluetooth (registered trademark) and near field communication (NFC). The in-vehicle control unit 20, for example, may read the key information from a passive or active IC tag that is included in the key device. In this case, other than the user terminal 121 and the deliveryman terminal 123, a contactless IC card or the like may be used as the key device, and the vehicle management apparatus 10 is not required to transmit the key information to the key device. Furthermore, as another aspect, the delivery management system 100 includes a server device (not shown in the drawings) that communicates with the in-vehicle control unit 20 and the key device, and this server device, after executing authentication of the key device and succeeding in the authentication, may allow the in-vehicle control unit 20 to unlock the door lock.

FIG. 2 shows operations that are executed by the delivery management system 100 until the user U1 receives the delivery item 101.

The user U1 operates the user terminal 121 to designate the delivery destination of the delivery item 101 and issue a delivery request to the vehicle management Apparatus 10 (S11). In step S11, information that designates the delivery destination vehicle 130 to which the delivery item 101 is delivered is transmitted from the user terminal 121 to the vehicle management apparatus 10.

Examples of the delivery destination vehicle 130 include a vehicle that is owned by the user U1, which may also include a vehicle that is rented by the user U1 in an aspect of car sharing, rental car, car lease, or the like. Furthermore, the delivery destination vehicle 130 may be a vehicle that is temporarily rented by the user U1 as a delivery location of the delivery item 101. For example, the delivery destination vehicle 130 may be a new or used display vehicle that is displayed in an automobile dealer.

The vehicle management apparatus 10 inquires of the in-vehicle control unit 20 that is equipped in the delivery destination vehicle 130 about a position of the delivery destination vehicle 130 (S13). The in-vehicle control unit 20 transmits to the vehicle management apparatus 10 position information that shows the position of the delivery destination vehicle 130 (S15).

The vehicle management apparatus 10 transmits to the deliveryman terminal 123 that is used by the user U2 a message that requests delivery (S17). In step S17, information that allows the user U2 to specify the position of the delivery destination vehicle 130, information that designates the delivery item 101, and the key information for the user U2 to unlock the door lock of the delivery destination vehicle 130 are transmitted to the deliveryman terminal 123.

Furthermore, the vehicle management apparatus 10 transmits to the in-vehicle control unit 20 the Authentication information for enabling unlocking by the user U2 (S19).

The user U2 picks up the delivery item 101 based on the information that is received by the deliveryman terminal 123 in step S17 and, by the delivery vehicle 125, goes to the delivery location P3 where the delivery destination vehicle 130 is parked. The user U2 causes the deliveryman terminal 121 to communicate with the in-vehicle control unit 20, and the in-vehicle control unit 20 executes authentication of the deliveryman terminal 123 (S21). If the authentication is successful, the door lock of the delivery destination vehicle 130 is unlocked in step S21. The user U2 opens the door and places the delivery item 101 in the delivery destination vehicle 130.

The in-vehicle control unit 20, when detecting the opening and closing of the door after unlocking of the delivery destination vehicle 130, determines that the delivery item 101 is placed, and locks the door lock of the delivery destination vehicle 130. The in-vehicle control unit 20 notifies the vehicle management apparatus 10 that the authentication is successful and that the delivery to the delivery destination vehicle 130 is completed (S23).

The vehicle management apparatus 10 transmits to the user terminal 121 the notification that the delivery to the delivery destination vehicle 130 is completed and the key information for the user U1 to unlock the door lock of the delivery destination vehicle 130 (S25). Furthermore, the vehicle management apparatus 10 transmits to the in-vehicle control unit 20 the authentication information for enabling unlocking by the user U1 (S27).

The user U1, by the user vehicle 120, goes to the delivery location P3 where the delivery destination vehicle 130 is parked. The user U1 causes the user terminal 121 to communicate with the in-vehicle control unit 20, and the in-vehicle control unit 20 executes authentication of the user terminal 121 (S29). If the authentication is successful, the door lock of the delivery destination vehicle 130 is unlocked in step S21. The user U1 opens the door and takes out the delivery item 101 from the delivery destination vehicle 130.

The in-vehicle control unit 20, when detecting the opening and closing of the door after unlocking of the delivery destination vehicle 130, determines that the delivery item 101 is taken out, and locks the door lock of the delivery destination vehicle 130. The in-vehicle control unit 20 notifies the vehicle management apparatus 10 that the authentication is successful and that the handing over to the user U1 is completed (S31).

The delivery management system 100 thus allows the user U1 and the user U2 to use the delivery destination vehicle 130 as a storage location of the delivery item 101, and the user U1 can receive the delivery item 101. Reception of the delivery item 101 can be done without the user U1 being restricted to a fixed location such as a home or a working place. Furthermore, it is advantageous in that even when the user U1 moves, the user U2 can promptly complete delivery of the delivery item 101.

Furthermore, the delivery management system 100 has a function to allow the user U1 to receive the delivery item 101 by, without the user U1 going to the delivery destination vehicle 130, moving the delivery destination vehicle 130. For example, when the user U1 moves to a move destination P5 via a scheduled route R1 due to an urgent business or a schedule change, the delivery management system 100 makes a choice between a method in which the user U1 moves to the delivery location P3 and receives the delivery item 101 and a method in which the delivery destination vehicle 130 moves to a reception location P7 that is close to the scheduled route R1 of the user U1.

The vehicle management apparatus 10 has a function to determine whether the user U1 is to move to the delivery location P3 or the delivery destination vehicle 130 is to move. If the move of the delivery destination vehicle 130 is determined to be preferable, the vehicle management apparatus 10 moves the delivery destination vehicle 130 to the reception location P7 that is on or close to the scheduled route R1. The user U1 can receive the delivery item 101 at the reception location P7 that is convenient when moving to the move destination P5.

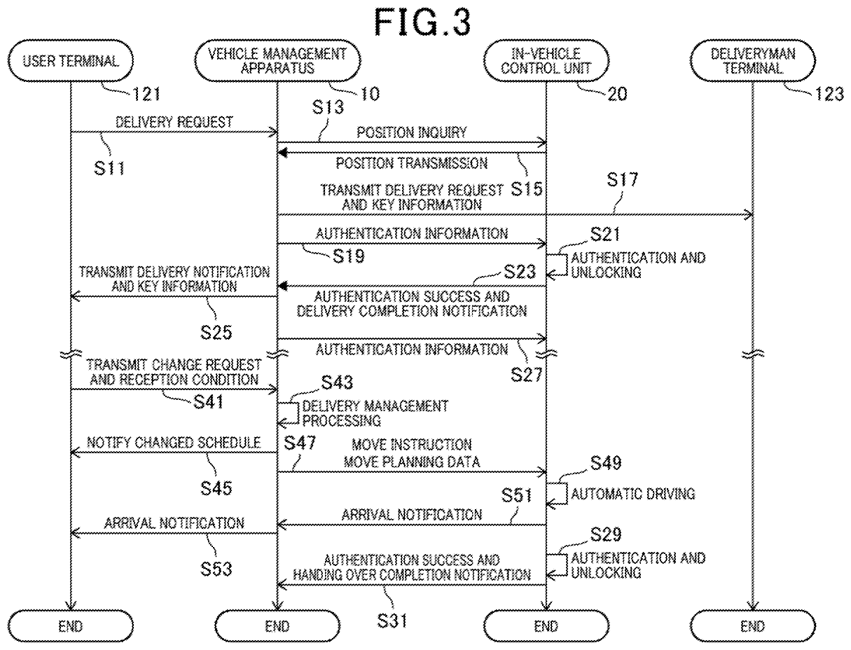

A series of the above operations is shown in FIG. 3.

FIG. 3 is a sequence view showing another operation example of the delivery management system 100. The operations of steps S11 to S31 in FIG. 3 are common to those explained in FIG. 2.

When the vehicle management apparatus 10 notifies the user terminal 121 of completion of the delivery in step S25 and then it is found that the user U1 is unable to go to the delivery location P3, the user U1 operates the user terminal 121 to transmit a change request to the vehicle management apparatus 10 (S41). In step S41, the request to change a schedule of reception of the delivery item 101 at the delivery location P3 is notified to the vehicle management apparatus 10. Furthermore, in step S41, a reception condition including the scheduled route R1 where the user U1 moves is transmitted to the vehicle management apparatus 10.

The reception condition is a condition to allow the user U1 to receive the delivery item 101, which includes, for example, information on an action schedule of the user U1. Specifically, the reception condition includes information in which positions and times of locations such as a destination and a via point to which the user U1 moves are associated with each other.

For example, the user terminal 121 may be configured to include a scheduler function that manages the action schedule of the user U1. The scheduler function is implemented by an application program when the user terminal 121 is, for example, a smartphone or a navigation device. In this configuration, the user terminal 121 stores schedule information that shows the action schedule of the user U1 that is managed by the scheduler function. In this case, the user terminal 121 may transmit, as the reception condition, the schedule information that is used in the scheduler function to the vehicle management apparatus 10. In step S41, the user U1 operates the user terminal 121 to transmit the change request and the reception condition to the vehicle management apparatus 10. The user terminal 121, when receiving the delivery completion notification in step S25, collates the delivery location P3 with a position of the user U1 and the schedule information and, based on whether the user U1 can go to the delivery location P3, transmits the change request.

Here, the vehicle management apparatus 10, after notifying completion of the delivery in step S25, may request the reception condition from the user terminal 121. Furthermore, the vehicle management apparatus 10 may perform processing to acquire the reception condition from the user terminal 121. Furthermore, when the schedule information that is managed by the user terminal 121 is stored in, for example, a server device that is connected to the user terminal 121 via a communication network, the vehicle management apparatus 10 may acquire from the server device the schedule information that is associated with the user U1.

The vehicle management apparatus 10 receives the change request in step S41 and executes delivery management processing based on the reception condition (S43). The delivery management processing is processing in which the vehicle management apparatus 10 determines, based on the reception condition, whether the delivery destination vehicle 130 is to be moved from the delivery location P3 and, if needed to be moved, determines the new reception location P7 according to the scheduled route R1.

The vehicle management apparatus 10, after determining reception location P7, changes the scheduled route R1 of the user U1 so as to go through the reception location P7 and generates a changed route R3, notifying the user terminal 121 of the change to the changed route R3 (S45). Furthermore, the vehicle management apparatus 10 transmits to the in-vehicle control unit 20 move planning data for moving the delivery destination vehicle 130 by automatic driving and issues to the in-vehicle control unit 20 a move instruction by automatic driving (S47). The move planning data is data for causing the delivery destination vehicle 130 to travel from the delivery location P3 to the reception location P7 along an automatic driving route R5.

The in-vehicle control unit 20, based on the move planning data that is transmitted from the vehicle management apparatus 10, executes automatic driving and causes the delivery destination vehicle 130 to travel to the reception location P7 (S49). The in-vehicle control unit 20 notifies the vehicle management apparatus 10 that the delivery destination vehicle 130 arrives at the reception location P7 (S51).

The vehicle management apparatus 10, when receiving from the in-vehicle control unit 20 the notification of the arrival at the reception location P7, notifies the user terminal 121 of the arrival of the delivery destination vehicle 130 (S53).

The user U1 moves the user vehicle 120 according to the changed route R3 that is notified from the vehicle management apparatus 10 to the user terminal 121 in step S45.

Here, based on the changed route R3 that is notified in step S45, the user terminal 121 may provide the user U1 with a route guidance for the user vehicle 120. For example, when the user terminal 121 is a navigation device that is equipped in the user vehicle 120, the user terminal 121 may generate a route for moving the user vehicle 120 based on the changed route R3 and, according to the generated route, provide the route guidance for the user vehicle 120. This function is also applicable to a configuration In which the user terminal 121 is configured by a computer such as a smartphone and installs an application program for a route guidance. Furthermore, the user terminal 121 may perform processing to include in the schedule information an event in which, according to the changed route R3, the reception location P7 is visited for reception of the delivery item 101. That is, the user terminal 121 adds to the schedule information an event in which the changed route R3 is visited, and updates the schedule information. The event to be added is an event in which the reception location P7 that is a reception point of the delivery item 101 is a via point, and may include a time at which the reception location P7 is visited and position information of the reception location P7.

The user U1, after arriving at the reception location P7, causes the user terminal 121 to communicate with the in-vehicle control unit 20, and the in-vehicle control unit 20 executes authentication of the user terminal 121 (S29). If the authentication is successful, the door lock of the delivery destination vehicle 130 is unlocked in step S21. The user U1 opens the door and takes out the delivery item 101 from the delivery destination vehicle 130. The in-vehicle control unit 20, when detecting the opening and closing of the door After unlocking of the delivery destination vehicle 130, determines that the delivery item 101 is taken out, and locks the door lock of the delivery destination vehicle 130. The in-vehicle control unit 20 notifies the vehicle management apparatus 10 that the authentication is successful and that the handing over to the user U1 is completed (S31).

In the above operations, after the vehicle management apparatus 10 notifies the user terminal 121 of the changed route R3 in step S45, the user terminal 121 may transmit, to the vehicle management, apparatus 10 information that shows an acceptance. In this case, the vehicle management apparatus 10, when enabling to receive from the user terminal 121 the information that shows the acceptance, proceeds to step S47 and issues the move instruction by automatic driving to the in-vehicle control unit 20. That is, on the condition that the user U1 causes the user terminal 121 to issue an instruction of the acceptance, the vehicle management apparatus 10 moves the delivery destination vehicle 130. Furthermore, the vehicle management apparatus 10, on the condition that the user U1 causes the user terminal 121 to issue the instruction of the acceptance, may generate the move planning data.

Thus, when the user U1 becomes unable to go to the delivery location P3 that is a scheduled reception location, the delivery management system 100 determines the new reception location P7 at the convenience of the user U1 and enables the reception of the delivery item 101.

Furthermore, the vehicle management apparatus 10, when determining not to move the delivery destination vehicle 130, notifies the user terminal 121 to go to the delivery location P3 to receive the delivery item 101, and the operations in FIG. 2 are executed.

Detailed configurations and operations of each unit relating to the above functions will be explained below.

### 3. Configuration of In-Vehicle System of Delivery Destination Vehicle

FIG. 4 is a functional block view showing a configuration of the in-vehicle system 200 that is equipped in the delivery destination vehicle 130.

The in-vehicle system 200 has the in-vehicle control unit 20, and various functional units that are placed in the delivery destination vehicle 130 and connected to the in-vehicle control unit 20.

The in-vehicle system 200 includes, for example, an object recognition device 201, a GNSS receiver 221, a driving operator 230, a brake device 231, a steering device 232, a travel driving force output device 233, and a door lock device 241. Furthermore, the in-vehicle system 200 includes a camera 202, a radar device 203, a finder 204, a microphone 211, a communication device 212 (receiver/transmitter), a human machine interface (HMI) 213, a vehicle sensor 214, and a near field communication device 215 (receiver/transmitter). Such devices and equipment are connected to each other by, for example, a multiplex communication line such as a controller area network (CAN) communication line, a serial communication line, or a wireless communication network. It should be noted that the configuration shown in FIG. 4 is merely one example, and part of the configuration may be omitted and further another configuration may be added thereto.

The object recognition device 201 is connected to the camera 202, the radar device 203, and the finder 204. The camera 202 is, for example, a digital camera using a solid state imaging element, and one or a plurality thereof are attached to any positions of the delivery destination vehicle 130 and image the vicinity including the front of the delivery destination vehicle 130. The radar device 203 radiates an electric wave such as a millimeter wave to the vicinity of the delivery destination vehicle 130 and detects the electric wave that is reflected by an object, detecting a position of the object and a distance and direction from the delivery destination vehicle 130 to the object. The finder 204, which is also called a light detection and ranging (LIDAR), irradiates the vicinity of the vehicle 130 with light and measures scattered light. The finder 204 detects a distance to a target based on a time from light emission to light reception. The object recognition device 201 has a CPU (Central Processing Unit) (not illustrated) and a memory (not illustrated) that stores programs and various data, and by executing, by the CPU, the programs stored in the memory, performs sensor fusion processing on the detection results by part or all of the camera 202, the radar device 203, and the finder 204 and recognizes the position, type, speed, and the like of the object. The object recognition device 201 outputs the recognition results to the in-vehicle control unit 20. Furthermore, the object recognition device 201 may output to the in-vehicle control unit 20 the detection results of the camera 202, the radar device 203, and the finder 204.

The communication device 212 uses, for example, a mobile communication network or a Wi-Fi (registered trademark) network to execute communication via the communication network 102.

The HMI 213 presents various information to an occupant who gets in the delivery destination vehicle 130, and accepts an input operation by the occupant. The HMI 213 includes various display devices, a speaker, a buzzer, a touch panel, a switch, a key, and the like.

The vehicle sensor 214 includes a vehicle speed sensor that detects a speed of the delivery destination vehicle 130, an acceleration sensor that detects an acceleration, a yaw rate sensor that detects an angular velocity around a vertical axis, a direction sensor that detects a direction of the delivery destination vehicle 130, and the like. Furthermore, the vehicle sensor 214 includes a door sensor that detects the opening and closing of the door of the delivery destination vehicle 130.

The near field communication device 215 executes Bluetooth, NFC, or other near field communication and executes wireless data communication between the user terminal 121 and the deliveryman terminal 123. The near field communication device 215 outputs to the in-vehicle control unit 20 data such as the key information that is acquired from the user terminal 121 or the deliveryman terminal 123. Furthermore, for example, when a contactless IC card or the like is used as the key device described above, the near field communication device 215 reads data from the IC card and outputs the read data to the in-vehicle control unit 20.

The global navigation satellite system (GNSS) receiver 221 specifies the position of the delivery destination vehicle 130 based on a signal that is received from a GNSS satellite. The GNSS receiver 221 outputs the specified position to the in-vehicle control unit 20.

The driving operator 230 includes, for example, an accelerator pedal, a brake pedal, a shift lever, a steering wheel, a deformed steering, a joystick, and other operators. To the driving operator 230, a sensor that detects an amount of operation or a presence or absence of operation is attached. The detection result of the sensor is output to either or both of the in-vehicle control unit 20 and the travel driving force output device 233, the brake device 231, and the steering device 232.

The brake device 231 includes, for example, a brake caliper, a cylinder that transmits hydraulic pressure to the brake caliper, an electric motor that generates the hydraulic pressure to the cylinder, and a brake electronic control unit (ECU). The brake ECU, according to information that is input from the in-vehicle control unit 20 or information that is input from the driving operator 230, controls a brake torque according to a braking operation so as to be output to each wheel. The steering device 232 includes, for example, a steering ECU and an electric motor and causes the electric motor to apply a force to a rack and pinion mechanism, changing a direction of a steering wheel. The steering ECU, according to the information that is input from the in-vehicle control unit 20 or the information that is input from the driving operator 230, drives the electric motor, changing the direction of the steering wheel. The travel driving force output device 233 outputs to a driving wheel a travel driving force for the vehicle to travel. The travel driving force output device 233 includes, for example, a driving source of the delivery destination vehicle 130 and an ECU that controls a driving source. The ECU, according to the information that is input from the in-vehicle control unit 20 or the information that is input from the driving operator 230, controls the above configuration.

The driving source of the delivery destination vehicle 130 may be, for example, an internal combustion engine such as a diesel engine or a gasoline engine, an electric motor, or a combination thereof.

The in-vehicle control unit 20 is, for example, a computer that includes a processor such as & central processing unit (CPU), and includes a storage that stores a program and data. Hardware that constitutes the in-vehicle control unit 20 is not limited to any specific aspect. The in-vehicle control unit 20 causes the processor to execute the program and functions as a communication controller 21, an automatic driving controller 22, and a lock controller 23.

The communication controller 21 controls wireless communication by the communication device 212 and transmits and receives various data to and from the vehicle management apparatus 10. In the operations shown in FIGS. 2 and 3, the communication controller 21, when receiving from the vehicle management, apparatus 10 an inquiry about the position (S13), transmits to the vehicle management, apparatus 10 the position information that shows the position of the delivery destination vehicle 130 that is detected by the GNSS receiver 221 (S15).

The communication controller 21 receives the authentication information that is transmitted from the vehicle management apparatus 10 (S19 and S27).

When the lock controller 23 unlocks the door lock and then the vehicle sensor 214 detects the opening and closing of the door, the communication controller 21 transmits to the vehicle management apparatus 10 the notifications of success of the authentication and completion of the delivery (S23) or the notifications of success of the authentication and completion of the handing over (S31).

The communication controller 21 receives the move instruction and the move planning data that are transmitted from the vehicle management apparatus 10 (S47).

The communication controller 21, when determining that the position of the delivery destination vehicle 130 that is detected by the GNSS receiver 221 is the reception location P7, notifies the vehicle management apparatus 10 of the arrival (S51).

The automatic driving controller 22 executes automatic driving according to a route and/or destination that are designated by the move planning data which the communication controller 22 receives from the vehicle management apparatus 10. The automatic driving controller 22 acquires the position and direction of the object and the distance from the delivery destination vehicle 130 that are recognized by the object recognition device 201 and executes a control to avoid the object. The automatic driving controller 22, based on the detection results of the vehicle sensor 214 and the position of the delivery destination vehicle 130 that is detected by the GNSS receiver 221, operates the brake device 231, the steering device 232, and the travel driving force output device 233 to cause the delivery destination vehicle 230 to travel.

The lock controller 23 executes authentication based on the authentication information that is received by the communication controller 21 and the key information that is acquired by the near field communication device 215. If the authentication is successful, the lock controller 23 operates the door lock device 241 (door lock mechanism) to unlock the door lock of the delivery destination vehicle 130. The lock controller 23, after unlocking the door lock using the door lock device 241, notifies the communication controller 21 of the opening and closing of the door when the vehicle sensor 214 detects the operations of the door opening and the opened door closing. Furthermore, the lock controller 23, when notifying of the opening and closing of the door, causes the door lock device 241 to lock the door lock of the delivery destination vehicle 130.

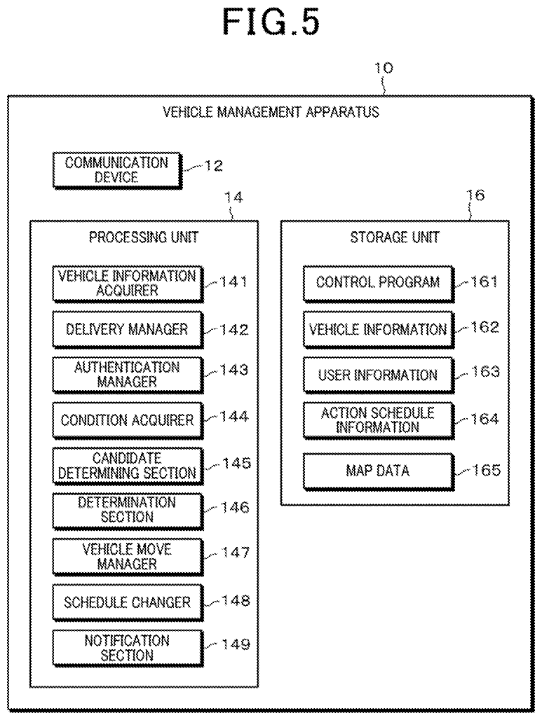

FIG. 5 is a functional block view of the vehicle management apparatus 10.

The vehicle management apparatus 10 includes a communication device 12 (receiver/transmitter), a processing unit 14, and a storage unit 16. The communication device 12 executes communication with the user terminal 121, the deliveryman terminal 123, and the in-vehicle control unit 20 via the communication network 102.

The processing unit 14 is, for example, a computer including a processor such as a CPU. The processing unit 14 is connected to the storage unit 16. The storage unit 16 stores various data that is processed by a control program 161 that is a computer program that is executed by the processing unit 14 and the processing unit 14, in a manner readable by the processing unit 14.

Hardware that constitutes the processing unit 14 and the storage unit 16 is not limited to any specific aspect. For example, the processing unit 14 may be configured by a single processor. Furthermore, the processing unit 14 may be a device in which a processor, a read only memory (ROM), a random access memory (RAM), and the like are integrated. The storage unit 16 may be configured by a nonvolatile storage device that stores a program and data in a nonvolatile manner, which specifically may include a magnetic storage device such as a hard disk or a semiconductor storage device such as a flash ROM. Furthermore, the storage unit 16 may include a volatile storage device that temporarily stores a program, data, and the like that are executed by the processing unit 14. Furthermore, the processing unit 14 and the storage unit 16 may be one integrated device.

The processing unit 14 includes, as functional elements or functional units, a vehicle information acquirer 141, a delivery manager 142, an authentication manager 143, a condition acquirer 144, a candidate determining section 145, a determination section 146, a vehicle move manager 147, a schedule changer 148, and a notification section 149. The processing unit 14 that is a computer executes the control program 161, and these functional elements that are included in the processing unit 14 are thereby implemented. It should be noted that the control program 161 may be stored in any computer readable storage medium. Instead of this, all or part of the above functional elements that are included in the processing unit 14 may be configured respectively by hardware including one or more electronic circuit components.

The storage unit 16 stores, in addition to the control program 161, vehicle information 162, user information 163, action schedule information 164, and map data 165.

The vehicle information 162 is information on the delivery destination vehicle 130 that is designated as the delivery destination of the delivery item 101. The vehicle information 162 includes information for the vehicle management apparatus 10 to perform, via the communication network 102, communication with the in-vehicle control unit 20 that is equipped in the designated delivery destination vehicle 130. The vehicle information 162 includes, for example, a network address of the in-vehicle control unit 20 or other identification information and identification information that identifies the delivery destination vehicle 130. Furthermore, the vehicle information 162 may include the position Information that shows the position of the delivery destination vehicle 130.

The user information 163 is information on the user U1 who receives the delivery item 101, which includes, for example, information for the vehicle management apparatus 10 to perform, via the communication network 102, communication with the user terminal 121 that is used by the user U1. The user information 163 may include information that specifies the delivery item 101.

The action schedule information 164 Includes information on the action schedule of the user U1 that is specified by the user information 163.

The map data 165 is, for example, information in which a link that shows a road and a node that is connected by the link express the road shape. The map data 165 may include a road curvature, point of interest (POI) information, and the like.

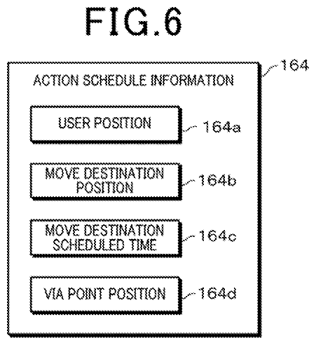

FIG. 6 is a view showing a configuration example of the action schedule information 164.

The action schedule information 164 includes a user position 164a, a move destination position 164b, a move destination scheduled time 164c, and a via point position 164d.

The user position 164a is information that shows the position of the user U1 when the user U1 starts to move to a move destination. The user position 164a is position information of the user terminal 121 when, for example, the user terminal 121 transmits the change request and the reception condition.

The move destination position 164b is position information of the move destination to which the user U1 moves. In the example of FIG. 1, the move destination is the move destination P5.

The move destination scheduled time 164c is information that specifies a scheduled time at which the user U1 moves to the move destination, which shows, for example, a scheduled time of arrival at the move destination and/or a time length of stay at the move destination.

The via point position 164d is information that shows, in a route where the user U1 moves to the move destination, a via point through which the user U1 goes to receive the delivery item 101, which is the position information of the reception location P7 in the example of FIG. 1.

The vehicle information acquirer 141 uses the communication device 12 to execute communication with the in-vehicle control unit 20 and acquires the position information of the delivery destination vehicle 130 that is designated by the user terminal 121 as the delivery destination of the delivery item 101.

The delivery manager 142 manages a delivery status of the delivery item 101 and the arrival of the delivery destination vehicle 130 at the reception location P7. The delivery manager 142, for example, when receiving with the communication device 12 the notification of completion of the delivery that is transmitted from the in-vehicle control unit 20, notifies the user terminal 121 of the completion of the delivery. Furthermore, the delivery manager 142, when receiving from the in-vehicle control unit 20 the notification of the arrival of the delivery destination vehicle 130 at the reception location P7, notifies the user terminal 121 of the arrival.

The authentication manager 143 transmits the hey information for unlocking the door lock of the delivery destination vehicle 130 to the user terminal 121 end the deliveryman terminal 123, and transmits the authentication information corresponding to the key information to the in-vehicle control unit 20.

The condition acquirer 144 acquires the change request and reception condition of the user U1 that are transmitted by the user terminal 121. The condition acquirer 144 extracts from the acquired reception condition the information on the action schedule of the user U1 and causes the storage unit 16 to store this information as the action schedule information 164.

The candidate determining section 145 determines a candidate for the reception location P7 for the user U1 to receive the delivery item 101 instead of the delivery location P3. The candidate determining section 145 searches for a location that is capable of accommodating the delivery destination vehicle 130 and exists on the scheduled route R1 of the user U1 that is shown by the action schedule information 164 or within a distance that is set by the scheduled route R1. The candidate determining section 145 determines the searched location as the candidate for the reception location.

The determination section 146, when the vehicle management apparatus 10 receives the change request from the user terminal 121, determines whether the delivery destination vehicle 230 to which the delivery item 101 is delivered is to be moved from a position that is acquired by the vehicle information acquirer 141. The determination section 146 determines whether to move the delivery destination vehicle 130 based on, for example, whether the candidate for the reception location that is searched for by the candidate determining section 145 conforms to the action schedule of the user U1. That is, the determination section 146 determines to move the delivery destination vehicle 130 when the user U1 and the delivery destination vehicle 130 can move to the candidate for the reception location without change of a move destination that is included in the action schedule of the user U1 and a time that is included in the action schedule.

Specifically, the determination section 146 acquires the position of the user U1, the position of the move destination P5 that is the move destination of the user U1, and the position of the candidate for the reception location that is searched for by the candidate determining section 145. The determination section 146 calculates an arrival time in the case where the delivery destination vehicle 130 moves from the delivery location P3 to the candidate for the reception location. Furthermore, the determination section 146 calculates an arrival time at the move destination P5 in the case where the user U1 moves to the move destination P5 via the candidate for the reception location. Here, the time at which the user U1 departs from the candidate for the reception location is after the time at which the delivery destination vehicle 130 arrives at the candidate for the reception location. That is, the determination section 146 calculates an arrival time in the case where the user U1 goes to the move destination P5 after not merely going through the candidate for the reception location but also receiving the delivery item 101 at the candidate for the reception location. In this processing, the determination section 146 may refer to the map data 165.

The determination section 146 determines to move the delivery destination vehicle 130 when the time at which the user U1 arrives at the move destination P5 via the candidate for the reception location is the same as a time of the move destination scheduled time 164c or when the time difference is within a predetermined time. Furthermore, the determination section 146 determines to move the delivery destination vehicle 130 when the time at which the user U1 arrives at the move destination P5 is within a scheduled time during which the user U1 stays at the move destination P5.

Furthermore, the determination section 146 determines not to move the delivery destination vehicle 130 when, by the candidate determining section 145, there is no candidate for the reception location that is capable of accommodating the delivery destination vehicle 130 or when the candidate for the reception location does not conform to the action schedule of the user U1.

The candidate determining section 145 may search for a plurality of positions as the candidate for the reception location. In this case, the determination section 146 performs the above determination on each of the plurality of the candidates for the reception location that are searched for by the candidate determining section 145.

The vehicle move manager 147 determines, as the move destination of the delivery destination vehicle 130, the candidate for the reception location in the case where the determination section 146 determines to move the delivery destination vehicle 130. The vehicle move manager 147 generates a move plan for moving the delivery destination vehicle 130 from the position that is acquired by the vehicle information acquirer 141 to the move destination. The vehicle move manager 147 converts the generated move plan into data in a form executable by the in-vehicle control unit 20 and uses the communication device 12 to transmit this data to the in-vehicle control unit 20.

The schedule changer 148 adds, as a new via point in the scheduled route R1 of the user U1, the candidate the reception location in the case where the determination section 146 determines to move the delivery destination vehicle 130. That is, the schedule changer 148 changes the action schedule information 164 that is generated by the condition acquirer 144. The schedule changer 148 determines that the position of the candidate for the reception location that is determined by the determination section 146 is the via point position 164d, and calculates a scheduled time at which the user U1 arrives at the position of the via point position 164d, generating a via point scheduled time 164e. Furthermore, the schedule changer 148 calculates a scheduled arrival time at the move destination P5 in the case where the added via point is gone through, updating the move destination scheduled time 164c.

The notification section 149 uses the communication device 12 to notify the user terminal 121 of the action schedule information 164 that is changed by the schedule changer 148. This notification corresponds to the notification of addition of the reception location P7 to the action schedule as the via point and the notification of the action schedule to which the via point is added.

### 4. Operations of Vehicle Management Apparatus

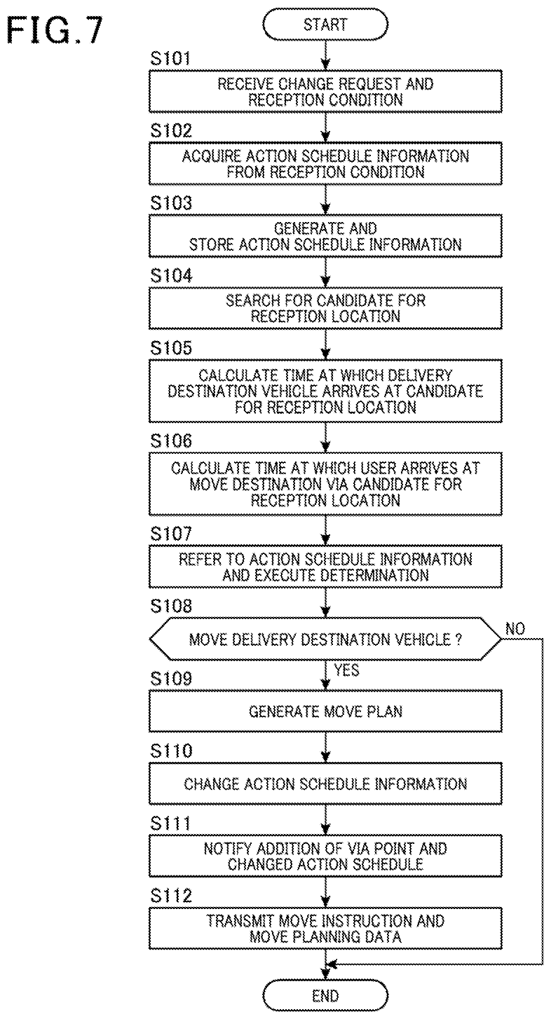

FIG. 7 is a flowchart showing operations of the vehicle management apparatus 10, in which the operations of the vehicle management apparatus 10 in steps S43, S45, and S47 in FIG. 3 are shown in detail.

In FIG. 7, the condition acquirer 144 executes steps S101 to S103, the candidate determining section 145 executes step S104, and the determination section 146 executes steps S105 to S108. The vehicle move manager 147 executes steps S109 and S112, the schedule changer 148 executes step S110, and the notification section 149 executes step S111.

The processing unit 14 uses the communication device 12 to receive the change request and the reception condition that are transmitted by the user terminal 121 (S101). The processing unit 14 acquires from the reception condition the information on the action schedule of the user U1 (S102) and causes the storage unit 16 to store this information as the action schedule information 164 (S103).

The processing unit 14 searches for the candidate for the reception location that is capable of accommodating the delivery destination vehicle 130 (S103). The processing unit 14 calculates the arrival time in the case where the delivery destination vehicle 130 is moved to the position of the candidate for the reception location (S105). The processing unit 14, based on the time that is calculated in step S105, calculates the arrival time in the case where the user U1 moves to the move destination via the candidate for the reception location (S106).

The processing unit 14 refers to the action schedule information 164 and, based on the time that is calculated in step S106, executes the determination on whether to move the delivery destination vehicle 130 or not (S107). The processing unit 14, when determining to move the delivery destination vehicle 130 (S108: YES), determines the candidate for the reception location as the move destination of the delivery destination vehicle 130 and generates the move plan for moving the delivery destination vehicle 130 to the candidate for the reception location (S109). The processing unit 14 adds to the action schedule information 164 the candidate for the reception location as the via point and changes the action schedule information 164 (S110). In step S110, as described above, processing is performed in which the candidate for the reception location is added to the action schedule information 164 as the new via point. This consequently adds the location and time of the new event to the action schedule information 164.

The processing unit 14, based on the updated action schedule information 164, performs the notification of addition of the via point and the notification of the action schedule that is shown by the changed action schedule information 164 (S111). The processing unit 14 transmits to the in-vehicle control unit 20 the move planning data that shows the move plan of the delivery destination vehicle 130, and issues the move instruction to the in-vehicle control unit 20 (S112). As described above, the processing unit 14, on the condition of enabling to receive from the user terminal 121 the information that shows the acceptance of the notification in step S111, may generate the move planning data and transmit this data to the in-vehicle control unit 20.

Furthermore, the processing unit 14, when determining not to move the delivery destination vehicle 130 (S108: NO), finishes the processing without executing steps S109 to S112. In this case, the processing unit 14 may notify the user terminal 121 so as to move to the delivery location P3 that is the scheduled reception location of the delivery item 101.

### 5. Modified Example

It should be noted that the present invention is not limited to the configuration of the above embodiment and may be implemented in various aspects without departing from the gist of the present invention.

For example, the above embodiment includes the configuration in which the user terminal 121 transmits to the vehicle management apparatus 10 the reception condition including the action schedule of the user U1; however, the delivery management system 100 may include a server (not shown in the drawings) that always manages the action schedule of the user U1. In this case, the vehicle management, apparatus 10 may acquire a changed action schedule of the user U1 from the server (not shown in the drawings) when the action schedule of the user U1 is changed.

Furthermore, in the above embodiment, after the delivery item 101 is delivered to the delivery destination vehicle 130 at the delivery location P3, a time limit may be set until the user U1 receives the delivery item 101 from the delivery destination vehicle 130. In this case, the determination section 146, based on whether the user U1 can arrive at the delivery location P3 within the time limit, may determine whether to move the delivery destination vehicle 130 to the reception location P7. For example, the candidate determining section 145, when the user U1 cannot arrive at the delivery location P3 within the time limit, searches for a location that is capable of accommodating the delivery destination vehicle 130 on a route from a user position P1 that is a current position of the user U1 to the delivery location P3 or within a predetermined distance from the route, determining this location as the candidate for the reception location. The determination section 146 may perform the determination in consideration of an arrival time in the case where the user U1 moves to the move destination P5 via the candidate for the reception location and a time at which the user U1 arrives at the candidate for the reception location.

### 6. Conclusion

As explained above, the vehicle management apparatus 10 of the present embodiment includes: the vehicle move manager 147 that acquires the position of the delivery destination vehicle 130 that is designated as the delivery destination of the delivery item 101; and the condition acquirer 144 that acquires the instruction from the user U1 of the delivery item 101, or the reception condition including the action schedule of the user U1. The vehicle management apparatus 10 includes the determination section 146 that determines, based on the reception condition, whether the delivery destination vehicle 130 to which the delivery item 101 is delivered is to be moved from the position that is acquired by the vehicle move manager 147.

A vehicle management method that is executed by the vehicle management apparatus 10 includes: a step of acquiring the position of the delivery destination vehicle 130 that is designated as the delivery destination of the delivery item 101; a step of acquiring the instruction from the user U1 of the delivery item 101, or the reception condition including the action schedule of the user U1; and a step of determining, based on the reception condition, whether to move the delivery destination vehicle 130 to which the delivery item 101 is delivered.

According to the configuration of the vehicle management apparatus 10, whether to move the delivery destination vehicle 130 for the user U1 to receive the delivery item 101 is determined based on the action schedule of the user U1. The delivery destination vehicle 130 thus moves at the convenience of the user U1, and the reception of the delivery item 101 can be done. Furthermore, it is advantageous in that, for example, when the move of the delivery destination vehicle 130 is not appropriate based on the action schedule of the user U1, the reception of the delivery item 101 is done without the move of the delivery destination vehicle 130, allowing the delivery item 101 to be delivered efficiently. Accordingly, this can reduce the burden on the user U1 to receive the delivery item 101 that is delivered to the delivery destination vehicle 130, for efficient package delivery.

The vehicle management apparatus 10 includes the candidate determining section 145 that determines the candidate for the reception location of the delivery item 101 that is capable of accommodating the delivery destination vehicle 130. The determination section 146 determines to move the delivery destination vehicle 130 when there is the candidate for the reception location that satisfies the reception condition based on the reception condition. Thus, when the move of the delivery destination vehicle 130 does not conform to the convenience of the user U1, the delivery destination vehicle 130 is not moved; accordingly, it is advantageous in allowing the delivery item 101 to be delivered efficiently.

The action schedule of the user U1 includes the move destination to which the user U1 moves and the time at which the user U1 arrives or stays at the move destination. The determination section 146 determines to move the delivery destination vehicle 130 when the user U1 and the delivery destination vehicle 130 can move to the candidate for the reception location without change of the move destination and the time that are included in the action schedule. Thus, moving the delivery destination vehicle 130 allows the user U1 to receive the delivery item 101 without significant change of the schedule of the user U1, which can reduce the burden on the user U1 to receive the delivery item 101. Furthermore, delivering the delivery item 101 can be completed promptly.

The vehicle management apparatus 10 includes: the vehicle move manager 147 that determines the move destination of the delivery destination vehicle 130 from the candidate for the reception location; the schedule changer 148 that adds, as the now via point, the position of the move destination of the delivery destination vehicle 130 to the action schedule; and the notification section 149 that notifies the user U1 of the addition of the event including the via point for the action schedule. Thus, when the delivery destination vehicle 130 is moved, the user U1 can be notified of the change of the schedule for receiving the delivery item 101.

The notification section 149 may transmit information for setting the via point for the route to the user terminal 121, in which the user terminal 121 is a navigation device that is equipped in the vehicle 120, and the vehicle 120 which the user U1 gets in is different from the vehicle 130 that is designated as the delivery destination of the delivery item 101. In this case, the user terminal 121 can perform the route guidance of the user vehicle 120 along the route including the added event. Accordingly, even when the reception location of the delivery item 101 is changed, the user U1 can receive the delivery item 101 more reliably. Furthermore, this can reduce the burden on the user U1 due to the change of the reception location.

The user terminal 121 which the notification section 149 notifies of the changed action schedule may be, for example, a navigation device that is equipped in the user vehicle 120 or a smartphone of the user U1 having a route guidance function. In this case, the notification section 149 notifies a route guidance terminal that is used by the user U1 of the action schedule to which the schedule changer 148 adds the via point. The user U1 thus can cause the user terminal 121 to execute navigation based on the changed action schedule.

The vehicle move manager 147, when enabling to acquire the information that shows the acceptance of the notification by the user U1, may generate the move plan for moving the delivery destination vehicle 130 from the position that is acquired by the vehicle move manager 147 to the move destination. In this case, the delivery destination vehicle 130 can be moved to the reception location by automatic driving or the like.

### REFERENCE SIGNS LIST

10: vehicle management apparatus

12: communication device

14: processing unit

16: storage unit

20: in-vehicle control unit

21: communication controller

22: automatic driving controller

23: lock controller

100: delivery management system

101: delivery item

102: communication network

120: user vehicle

121: user terminal

123: deliveryman terminal

130: delivery destination vehicle

141: vehicle information acquirer

142: delivery manager

143: authentication manager

144: condition acquirer

145: candidate determining section

146: determination section

147: vehicle move manager

148: schedule changer

149: notification section

161: control program

163: user information

164: action schedule information

165: map data

200: in-vehicle system

201: object recognition device

212: communication device

215: near field communication device

221: GNSS receiver

230: driving operator

231: brake device

232: steering device

233: travel driving force output device

241: door lock device

What is claimed is:

1. A vehicle management apparatus, comprising:
a vehicle information acquirer acquiring a position of a vehicle designated as a delivery destination of a package;
a condition acquirer acquiring an instruction from a recipient of the package, or a reception condition including an action schedule of the recipient; and
a determination section determining, based on the reception condition, whether the vehicle that has the package delivered is to be moved from the position acquired by the vehicle information acquirer.

2. The vehicle management apparatus according to claim 1, comprising a candidate determining section determining, for a reception location of the package, a candidate capable of accommodating the vehicle,
wherein the determination section determines to move the vehicle when there is the candidate for the reception location satisfying the reception condition based on the reception condition.

3. The vehicle management apparatus according to claim 2, wherein the action schedule comprises a move destination to which the recipient moves and a time at which the recipient arrives or stays at the move destination, and
the determination section determines to move the vehicle when the recipient and the vehicle can move to the candidate for the reception location without change of the move destination and the time that are included in the action schedule.

4. The vehicle management apparatus according to claim 2, comprising:
a vehicle move manager determining, from the candidate for the reception location, a move destination of the vehicle;
a schedule changer adding, as a new via point, a position of the move destination of the vehicle to the action schedule; and
a notification section notifying the recipient of addition of an event including the via point for the action schedule.

5. The vehicle management apparatus according to claim 4, wherein the notification section, to a navigation device equipped in a vehicle which the recipient gets in and is different from the vehicle designated as the delivery destination of the package, transmits information for setting the via point on a guidance route.

6. The vehicle management apparatus according to claim 4, wherein the vehicle move manager, when enabling to acquire information showing an acceptance of the notification by the recipient, generates a move plan for moving the vehicle from the position acquired by the vehicle information acquirer to the move destination.

7. A vehicle management method, comprising:
a step of acquiring a position of a vehicle designated as a delivery destination of a package;
a step of acquiring an instruction from a recipient of the package, or a reception condition including an action schedule of the recipient; and
a step of determining, based on the reception condition, whether to move the vehicle that has the package delivered.
